(19) United States
(12) Patent Application Publication
(10) Pub. No.: US 2004/0090069 A1
(43) Pub. Date: May 13, 2004

(54) Coupling for connecting two tubes

(76) Inventors: Antoine Jausovec, Tournan En Brie (FR); Bruno Poncet, Rubelles (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/284,161

(22) Filed: Oct. 31, 2002

(30) Foreign Application Priority Data
Oct. 31, 2001 (FR) 01 14103

(51) Int. Cl. F16L 25/00

(52) U.S. Cl. 285/386

(57) ABSTRACT

A connection for the junction of two tubes, through which a fluid under pressure flows, comprises a female element and a male element. The male element is adapted to be fitted axially in the female element and secured to the female element via a primary attachment member. The male and female elements dispose respectively of a female duct and a male duct, each of them opening on either side of the element in which it is located. Each of these ducts also comprises a first as well as a second extremity, these first extremities of the female duct and the male duct opening respectively on the flat surface of the female element and on the flat surface of the male element. The connection is manufactured in such a way that the flat surface of the female element and the flat surface of the male element are in flat contact.

### TECHNICAL FIELD

The technical field of the present invention is that of couplings for connecting tubes through which a fluid passes under pressure. In particular, the field into which the invention falls is especially that of couplings for capillary tubes used to make the connection between measurement machines and apparatuses, such as pressure scanners.

### PRIOR ART

Various embodiments have already been proposed in this field.

With reference to FIG. 1 which depicts a view in part section of a first coupling of the prior art, there is known a coupling 40 comprising a body 42 able to receive a tube 44. This device also has means for holding the tube 44 on the body 42 and means for sealing the connection between these two components. These means comprise a nut 46 and two biconical rings 48, 50. The tube 44 is held and sealed by the contraction of the two biconical rings 48, 50 under the action of the nut 46 being screwed onto the body 42, the tube 44 being prevented from translational movement with respect to the body 42 in the direction of the screwing.

However, this solution does have numerous disadvantages. In this type of device, the material of the tube needs to be softer than that of the coupling so that the biconical rings can deform the tube and hold it in the body. If it is not, the tube needs to be entirely annealed.

In addition, the surface finish of the tubes plays a very important part in obtaining sealed connections. In consequence, with such sealing means, any tube whose surface has impressions, scratches, bumps or indeed any other type of surface defect, is therefore very difficult to seal.

Finally, the type of coupling known from the prior art as depicted in FIG. 1 has the disadvantage of having a lengthy and tricky assembly process. What happens is that once the various elements have been fitted together, the tightening of the nut has to be checked so as to tighten it enough to seal the device without damaging it. Once complete, the assembly is followed by a compulsory check on the separation between the body and the nut, so as to make sure that assembly has been performed precisely. Finally, it can be found that the tubes deform upon assembly and can therefore only be used once.

A second type of coupling for connecting two tubes through which a fluid passes under pressure is known. This is depicted in FIG. 2 which depicts a sectioned view of a coupling in the coupled position. With reference to this FIG. 2, the coupling 20 consists of a male termination 22 and of a female termination 24. These two terminations 22, 24 are designed to receive tubes under pressure (not depicted) and to fit axially one inside the other in a coupled position. The male termination 22 bearing the first tube for coupling comprises a drilling 28 opening right through this termination 22; when it is introduced into the female termination 24, it pushes a valve 26 and enters a cavity 32 communicating directly with a drilling 30 made in the female termination 24. This drilling 30 also acts as a housing for the second tube under pressure for connecting, this making it possible, by way of a seal 34, to have a completely sealed coupling between two tubes under pressure.

However, this type of coupling has one major disadvantage in relation to the flow of the fluid through the coupling. What happens is that it has been found, during measurements taken using such couplings to make the connection between measurement apparatuses and machines, that the flow of the fluid experiences parasitic effects leading to imperfections in the quality of these measurements. These imperfections are due in part to the passage of the fluid under pressure through the cavity 32, the flow of the fluid being greatly disrupted therein.

### SUMMARY OF THE INVENTION

It is therefore an object of the invention to overcome the various disadvantages mentioned hereinabove, by presenting a coupling that makes it possible to greatly increase the quality of the measurements taken, while at the same time remaining of simple design.

To achieve this, the subject of the invention is a coupling for connecting two tubes through which a fluid passes under pressure, comprising a female element and a male element able to be pushed axially into said female element and fixed to the latter by a primary fixing means. These female and male elements have, respectively, a female canal and a male canal, each one opening on each side of the element in which it lies. Each of these canals also comprises a first and a second end, the first end of the female canal lying facing the first end of the male canal, these first ends of the female canal and of the male canal opening respectively onto a planar surface of the female element and onto a planar surface of the male element. The second ends of the female and male canals are each able to receive a tube which is fixed in leaktight fashion in said second end by secondary fixing means, the male element further comprising at least one seal. The coupling is produced in such a way that the planar surface of the female element and the planar surface of the male element are in planar contact.

The main advantage of this invention lies in the use of a coupling that allows continuity of the flow of air between the two tubes for connecting. The particular arrangement of the means culminating in the embodiment of the invention minimizes the parasitic effects on the air flow and thus makes it possible to obtain measurements with better quality than those taken using couplings of the prior art, particularly when measuring pressure in the presence of transient phenomena, at a frequency in excess of 100 Hz.

The coupling according to the invention allows this coupling to be assembled and disassembled several times without in any way deteriorating the elements of which it is made. It is therefore possible for the same coupling to be reused several times, and this presents a considerable advantage when measurements need to be taken from various machines using the same measurement apparatus.

As a preference, the coupling according to the invention has primary fixing means comprising a nut having a first and a second end, the first end collaborating with a thread situated on one of said male and female elements, the second end bearing against the other of said male and female elements. The nut in a screwed-on position, is able to keep said planar surface of the female element in contact with said planar surface of the male element.

The simplicity of the means used in this particular configuration allows a saving in cost by comparison with the solutions which exist in the prior art.

As a preference, the primary fixing means can be operated by hand.

Advantageously, the coupling can therefore be assembled and disassembled quickly using simple means which are easy for the operator to handle, without requiring special-purpose tooling.

### BRIEF DESCRIPTION OF THE DRAWINGS

This description will be given with reference to the appended drawings among which:

FIGS. 1 and 2 already described, illustrate the prior art,

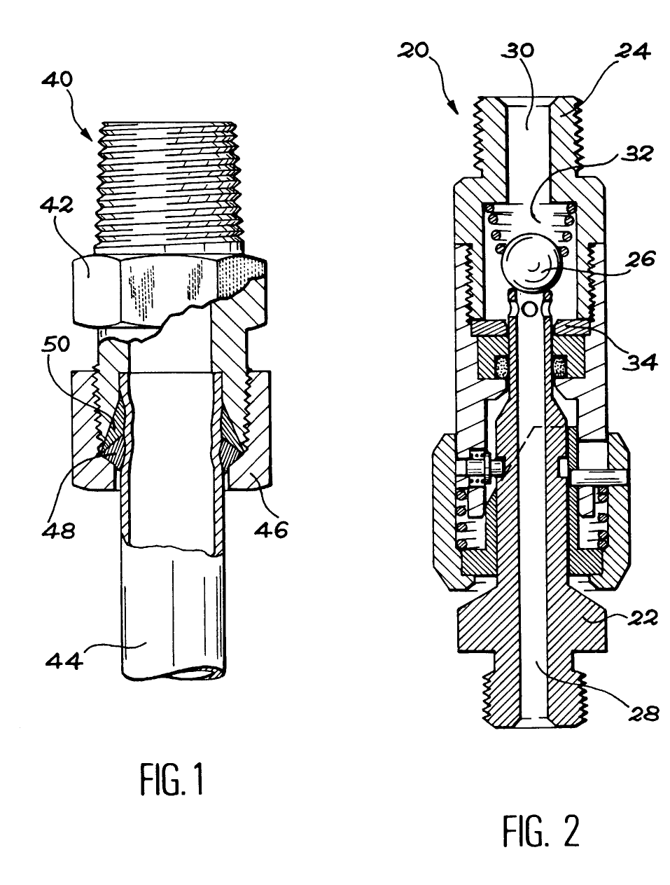

FIG. 3 depicts a view in longitudinal section of the coupling according to the invention when two tubes are coupled.

### DETAILED DESCRIPTION OF PARTICULAR EMBODIMENTS

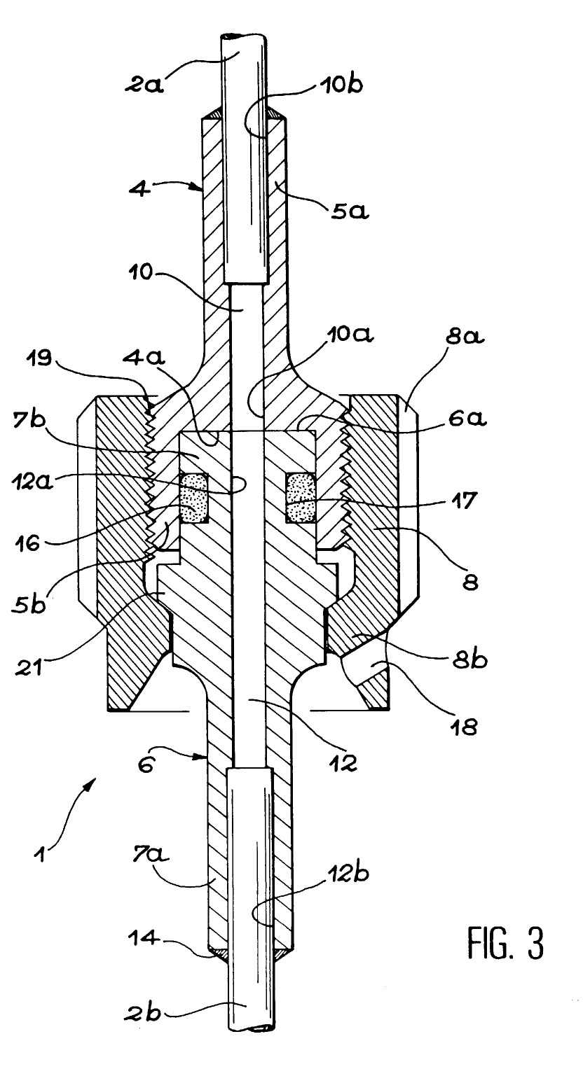

Reference is made to FIG. 3 which shows a coupling 1 intended to join two tubes 2a, 2b through which a fluid passes under pressure. The tubes 2a, 2b for coupling are preferably capillary tubes made of stainless steel or nylon (registered trademark) or of any other type.

This coupling 1 comprises two major elements which are the female element 4 and the male element 6.

The female element 4 has, passing through it, a female canal 10 opening on each side of the element. It is in this female canal 10, at a first portion 5a of the female element 4, that one of the two tubes 2a, 2b is fixed in a sealed manner so as to communicate with the inside of this female canal 10. A second portion 5b of the female element 4 has a cylindrical bore in the end of which the female canal 10 opens. This second portion 5b has a thread 19 on its exterior surface. The female canal 10 comprises a first end 10a and a second end 10b, the first end 10a lying in the second portion 5b of the female element 4 and the second end 10b lying in the first portion 5a of this same female element 4. It should be noted that, according to the invention, the female canal 10 at its first end 10a opens onto a planar surface 4a of the female element 4, forming the end of the aforementioned cylindrical bore.

The second major element is the male element 6, it too comprising a male canal 12 opening on each side of this male element 6. It is also in this male canal 12, at a first portion 7a of the male element 6, that the other pressurized tube 2a, 2b is fixed in a sealed manner so as to communicate with the inside of the male canal 12. A second portion 7b of the male element 6 is cylindrical, with roughly the same diameter as the cylindrical bore made in the second portion 5b of the female element 4. Formed in the second portion 7b of the male element 6 is a groove 17 in which there is a seal 16, preferably of circular cross section. The two portions 7a and 7b of the male element 6 are separated by a projecting shoulder 21. The male canal 12 comprises a first end 12a and a second end 12b, the first end 12a lying in the second portion 7b of the male element 6 and the second end 12b lying in the first portion 7a of this same male element 6. It should also be noted that, according to the invention, the male canal 12, at its first end 12a, opens onto a planar surface 6a of the male element 6.

The female element 4 and the male element 6 are intended to be pushed axially together one inside the other to connect the two tubes under pressure 2a, 2b. The second portions 5b and 7b of the female 4 and male 6 elements are therefore designed to collaborate with one another so that the first ends 12a, 10a of the male 12 and female 10 canals can face each other.

Once pushed together one inside the other, the two, female 4 and male 6, elements are such that the cylindrical part of the second portion 7b of the male element 6 is in the cylindrical bore of the second portion 5b of the female element 4. In addition, the planar surfaces 4a and 6a of the female 4 and male 6 elements are in planar contact. This particular configuration thus makes it possible to ensure continuity in the flow of the pressurized fluid, the passage cross sections of the male and female canals 12, 10 being more or less identical.

The invention also comprises primary fixing means the purpose of which is to hold and fix the two male and female, elements 6, 4 in the position in which the two planar surfaces 4a and 6a are in planar contact.

For that, use may be made of a simple nut 8 having a first end 8a and a second end 8b. In this case, the first end 8a, which is threaded, collaborates with the thread produced on the exterior surface of the second portion 5b of the female element 4. Furthermore, the second end 8b of the nut 8 presses against the shoulder 21 of the male element 6, thus allowing the assembly to be tightened along the axis common- to the canals 10 and 12. It is, however, notable that assembly may be performed using a thread produced on the second portion 7b of the male element 6 and a shoulder produced on the second portion 5a of the female element 4.

The fact of using such an assembly allows the operator to tighten the nut 8 by hand, without the need for special-purpose tooling. Use will therefore be made of a splined or knurled nut 8, with a metric thread or one using any other measurement unit such as inches. Finally, this nut 8 may be equipped with a drilling 18 so that it can be wired on with a locking wire.

Note that secondary fixing means are used in the invention to make the connection between the male 6 and female 4 elements and the pressurized tubes 2a, 2b. To do this, use may then be made of any type of means, such as brazing, welding, bonding or alternatively of mechanical means.

As a preference, the coupling 1 according to the invention can be used for making the interface between machines on which tests are to be performed and measuring hardware such as pressure scanners.

Of course, various modifications can be made by those skilled in the art to the coupling which has just been described solely by way of nonlimiting example.

1. Coupling (1) for connecting two tubes (2a, 2b) through which a fluid passes under pressure, comprising a female element (4) and a male element (6) able to be pushed axially into said female element (4) and fixed to the latter by a primary fixing means, these female (4) and male (6) elements having, respectively, a female canal (10) and a male canal (12), each one opening on each side of the element in which it lies and having a first (10a, 12a) and a second (10b, 12b) end, the first end (10a) of the female canal (10) lying facing the first end (12a) of the male canal (12), these first ends (10a, 12a) of the female canal (10) and of the male canal (12) opening respectively onto a planar surface (4a) of the female element (4) and onto a planar surface (6a) of the male element (6), said second ends (10b, 12b) of the female (10) and male (12) canals each being able to receive a tube (2a, 2b) which is fixed in leaktight fashion in said second end (10b, 12b) by secondary fixing means (14), the male element (6) further comprising at least one seal (16), characterized in that said planar surface (4a) of the female element (4) and said planar surface (6a) of the male element (6) are in planar contact.

2. Coupling (1) for connecting two tubes (2a, 2b) according to claim 1, characterized in that the primary fixing means comprise a nut (8) having a first (8a) and a second (8b) end, the first end (8a) collaborating with a thread (19) situated on one of said male (6) and female (4) elements, the second end (8b) bearing against the other of said male (6) and female (4) elements, the nut (8) in a screwed-on position, being able to keep said planar surface (4a) of the female element (4) in contact with said planar surface (6a) of the male element (6).

3. Coupling (1) for connecting two tubes (2a, 2b) according to claim 1 or claim 2, characterized in that the primary fixing means can be operated by hand.

4. Coupling (1) for connecting two tubes (2a, 2b) according to any one of the preceding claims, characterized in that the primary fixing means comprise at least one drilling (18) for using a thread-locking wire.

5. Coupling (1) for connecting two tubes (2a, 2b) according to any one of the preceding claims, characterized in that the secondary fixing means (14) are such as bonding.

6. Coupling (1) for connecting two tubes (2a, 2b) according to any one of claims 1 to 5, characterized in that the secondary fixing means (14) are such as brazing.

7. Coupling (1) for connecting two tubes (2a, 2b) according to any one of claims 1 to 5, characterized in that the secondary fixing means (14) are such as welding.

8. Coupling (1) for connecting two tubes (2a, 2b) according to any one of claims 1 to 5, characterized in that the secondary fixing means (14) are mechanical means.
